(19) United States
(12) Patent Application Publication
(10) Pub. No.: US 2009/0142591 A1
(43) Pub. Date: Jun. 4, 2009

(54) Disposable Drink Glass Marker

(76) Inventor: Emily Rusley Brown, Broken Arrow, OK (US)

Correspondence Address: Emily Brown, 3401 S. Willow Ave., Broken Arrow, OK, 74012, US

(21) Appl. No.: 11/949,045

(22) Filed: Dec. 3, 2007

(51) Int. Cl. B32B 7/12

(52) U.S. Cl. 428/343

(57) ABSTRACT

What is new and unique about this invention is that it sticks to a drinking glass, unlike traditional wine glass charms. It can also be written on, stamped on, or printed on, therefore it can be customized by the user. Once the user is done with the disposable, self-adhesive drink marker, they can peel it off of the glass and dispose of it.

This invention is a self-adhesive, disposable drink glass marker. It is much like a wine glass charm used to mark your glass. A disposable drink glass marker is like a name tag, but you put it on your wine glass, coffee cup, etc. Thus, marking your glass so others won't mistakenly pick it up and drink from it. A person can personalize the disposable drink glass marker with a pen, marker, etc. by writing on the marker.

The disposable drink glass marker is made from cardstock paper, paper, plastic, or any disposable material, and it has a sticky adhesive on one side. The adhesive holds it to the glass. The non-adhesive side of the marker can be written or printed on.

### BACKGROUND OF THE INVENTION

This invention was created to expand upon the design of wine glass charms, which are used to decorate or mark your beverage. Disposable drink glass markers, however, can be customized to mark your beverages. I created the idea when I was thinking of a way to put people's names on their glass, and there wasn't a cost-efficient way to do it.

### BRIEF SUMMARY

With this invention, you can write anybody's name on the drink glass marker, and adhere (stick it) to the glass. Many people have a specific event in which they have many people attend, and they have the same type of drinking glass for each individual to use. Therefore, you can lose your drink or pick up the wrong one. It's very expensive to buy 50 wine charms if you're having an event that 50 people are attending. With this invention you can cheaply customize a drink marker for each glass, and when the event is over you can peel off the drink marker and dispose of it.

### DETAILED DESCRIPTION

The disposable drink glass marker is made from cardstock paper, paper, plastic, or any disposable material, and it has a sticky adhesive on one side. The adhesive holds it to the glass. There are only two products used in the makeup of this invention—the paper (or other disposable material), and the adhesive. Therefore, making it a very easy and affordable way to mark a glass. The non-adhesive side of the marker can be written or printed on. The disposable material can be cut to any design or shape, and then the adhesive is applied to one side of the glass.

1. This invention is a disposable, self-adhesive marker used to mark drinking glasses, coffee cups, etc. It sticks to the glass and can be customized.
